(19) United States
(12) Patent Application Publication
(10) Pub. No.: US 2022/0366490 A1
(43) Pub. Date: Nov. 17, 2022

(54) AUTOMATIC DECISIONING OVER UNSTRUCTURED DATA

(71) Applicant: Wells Fargo Bank, N.A., San Francisco, CA (US)

(72) Inventors: Srimoyee Duttagupta, Bangalore (IN); Pranshu Sharma, New Delhi (IN); Naveen Gururaja Yeri, Bangalore (IN); Hemalatha AC, Bangalore (IN); Dipan Banerjee, Bangalore (IN); Alan On Yau, Tustin, CA (US); Michelle Sunna Nowe, Pasadena, CA (US); Siddhartha Mishra, Kushinagar (IN); Manesh Saini, New York City, NY (US); Hasan Adem Yilmaz, San Diego, CA (US); Brandon Trujillo, San Francisco, CA (US)

(21) Appl. No.: 16/672,172

(22) Filed: Nov. 1, 2019

(51) Int. Cl. G06Q 40/02; G06F 16/35; G06K 9/62; G06N 3/04; G06K 9/66

(52) U.S. Cl. CPC G06Q 40/025; G06F 16/353; G06F 16/358; G06K 9/6257; G06N 3/04; G06K 9/66

(57) ABSTRACT

Automatic decisioning associated with unstructured data is disclosed. Unstructured data, such as that associated with comments of an underwriter regarding a credit decision, can be received. Text mining can be performed to extract features from the unstructured data. The extracted features can subsequently be provided as input to a machine learning model configured to return a prediction of a class associated with the unstructured data. The predicted class, such as approved or rejected, can subsequently be conveyed for display on a display device.

### BACKGROUND

Underwriting is a process in which an entity assumes a financial risk for a fee. For example, a financial institution that loans money to an individual collects interest on the loan and takes on the risk that the individual will not repay the loan. In another example, a company can charge an entity a premium for assuming the risk associated with insuring people or assets.

Underwriters are individuals who assess risk associated with an applicant for a loan or insurance, for instance. An underwriter decides whether to approve or decline an application based on risk assessment. For example, an application with acceptable risk can be approved while an application with unacceptable risk can be declined. Underwriters consider a number of different factors, including credit attributes, associated with risk in determining whether or not to approve or reject an application. These factors are documented by underwriters in a free-form textual comment.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to automatic decisioning over unstructured data. Unstructured data associated with written comments, is subject to text mining. Text mining transforms the unstructured data into actionable data for further use by way of one or more processes. A predictive machine learning model can be layered on top of text mining. The predictive machine learning model can be created to classify a target of a comment based on substance of the comment extracted by text mining. Furthermore, a corpus of training data including comments and associated decisions can be utilized to train the predictive machine learning model.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation.

FIG. 2 is a schematic block diagram of a decisioning system.

FIG. 3 is a schematic block diagram of a text mining component.

FIG. 4 is a bifurcated word cloud diagram.

FIG. 5 depicts an example artificial neural network for text classification.

FIG. 6 is a flow chart diagram of a method of application classification.

FIG. 7 is a flow chart diagram of a method of creating a predictive model.

FIG. 8 is a flow chart diagram of a method of text classification.

FIG. 9 is a schematic block diagram illustrating a suitable operating environment for aspects of the subject disclosure.

### DETAILED DESCRIPTION

Underwriters document factors associated with approval or rejection of an application in a comment. The comment references factors or attributes, such as credit attributes, considered by an underwriter in making a judgement regarding an application. Moreover, the comment can be specified as free-form text, or in other words, in unstructured data. Since the comment is unstructured, a judgement is not subject to analysis or automation.

Details provided herein generally pertain to automatic decisioning over unstructured data. Data interpretation is a review of data, for example from a loan application, for the purpose of arriving at an informed conclusion. The result of data interpretation can be a written explanation or comment documenting factors. Moreover, the comment can be specified in an unstructured, or free-form, format. Text mining can be performed to transform unstructured data into machine actionable data for further processing. For instance, factors within a comment can be extracted. Moreover, machine learning can be integrated with text mining to automate decision making with respect to the target of a comment. Unstructured data, for example from an underwriter comment, can be provided to a predictive model that automatically classifies a target of the comment, such as a loan application, as approved or rejected. For example, a supervised learning approach can be employed in which the model is trained to make approval decisions based on a corpus of data comprising comments and associated labels identifying classifications of the target of the comments.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

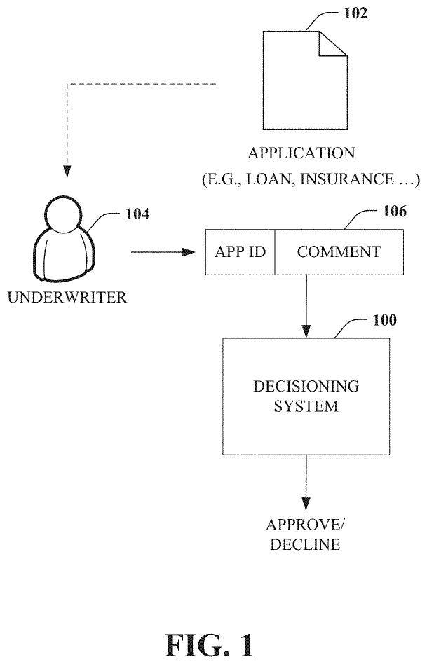

Referring initially to FIG. 1, an overview of an example implementation is illustrated and described. As depicted, the implementation includes decisioning system 100, application 102, underwriter 104, and comment 106. The decisioning system 100 can receive the comment 106, which is associated with application 102 and specified by the underwriter 104, as input, and output an approval or rejection decision. Optionally, a degree of confidence associated with such a decision can also be output.

The application 102 captures a formal request, for example for credit or insurance. The application includes data specified by a user. For example, a user can complete an online application for a loan or insurance policy including pertinent information such as name, address, age, income, or prior health issues, among other data solicited by the application. The data captured by the application can be stored as structured data, for example, in database or spreadsheet fields.

The underwriter 104 is an individual, or alternatively an automated bot, that reviews the application 102 and makes a decision regarding acceptance or rejection of the application. For example, the underwriter 104 can analyze application data to determine risk associated with approving a loan or insurance policy. In the context of a loan, the underwriter may be concerned with credit factors or attributes such as payment to income ratio and disposable income. The underwriter 104 identifies and documents relevant credit factors in an origination comment 106 and makes a decision on whether or not to approve or reject the application 102 based on the credit factors.

The comment 106 is a written note representing the result of an interpretation of application data. Conventionally, the comment is entered in free-form, and thus lacks structure. In this way, the underwriter 104 is unconstrained in how factors are represented and supported. Unlike structured data, however, unstructured data of comment is not suitable for analysis. Furthermore, specialized terminology associated with a particular domain can also be problematic. Consider for example, comment 106 associated with an automobile loan decision as follows: “risk on deal is prev bk, age of collateral, ok with disp>2 k with pti and dr inline.” In other words, risk associated with approving the loan is a previous bankruptcy and the age of the automobile as collateral, but the individual's disposable income is greater than two thousand dollars with payment to income and debt ratios in line with what is acceptable. Nevertheless, this meaning is not readily apparent in this unstructured and domain-specific form.

The decisioning system 100 receives the unstructured comment 106 as input and outputs an approval or rejection decision for the application 102 based on the unstructured comment 106. The decisioning system 100 can employ text mining techniques to extract factors from the unstructured comment 106. Further, the decisioning system 110 can employ machine learning to automatically produce an approval or rejection decision. In one instance, a supervised learning approach can be employed. In this case, a machine learning model can be created, or trained, with a corpus of training data including a plurality of comments for myriad applications and associated decisions.

The decisioning system 100 can be employed in a variety of scenarios. First, the decisioning system 100 can enable automatic approval or rejection based on the comments. For instance, if a loan decision is appealed, the decisioning system 100 can be employed alone or in conjunction with an underwriter to make a decision on the appeal. Second, the decisioning system 100 can be utilized as a performance review tool for decision makers, such as underwriters. Without such oversight, a financial institution could be approving risky applications or rejecting applications with acceptable risk. Further, the decisioning system 100 can be embodied as a decision tool that a decision maker can employ to help make decisions. For example, a decision maker can compare her decision to a decision suggested by the tool.

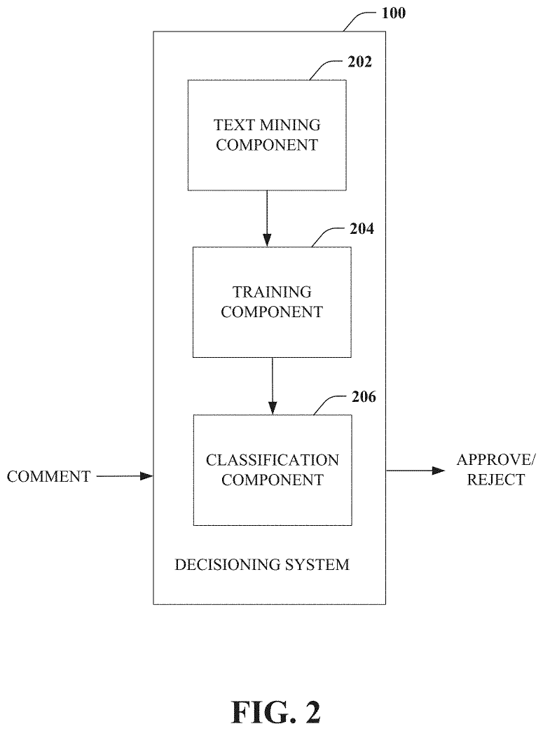

FIG. 2 illustrates a sample decisioning system 100 in further detail. As shown, the decisioning system 100 includes text mining component 202, training component 204, and classification component 206. The text mining component 202 is configured to derive quality information from textual data. For instance, the text mining component 202 can analyze unstructured or semi-structured comments and extract topics, concepts, or themes automatically without manual intervention. The text mining component 202 can employ various technologies including natural language processing to enable understanding and further processing of text content in a particular domain. For example, consider again a comment from an auto loan underwriter noting: “risk on deal is prev bk, age of collateral, ok with disp>2 k with pti and dr inline.” From this comment, the text mining component 202 can identify topics, concepts, or themes corresponding to credit factors, such as risk, bankruptcy, collateral, disposable income (di), payment to income ratio (pti), and debt ratio (dr).

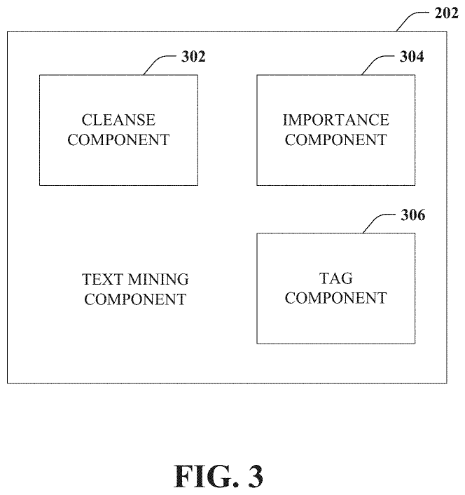

Turning attention to FIG. 3, a sample text mining component 202 is illustrated in further detail. The text mining component 202 includes cleanse component 302, importance component 304, and tag component 306. The cleanse component 302 can retrieve data and prepare the data for subsequent processing. For example, text data can be pre-processed to remove empty spaces, remove stop words (e.g., a, the, of . . . ), and lemmatize data to group words with different inflected forms, among other things. The cleanse component 302 can further exclude applications without comments, extract frequent and infrequent features, and determine features of text data such as character lengths and nulls. The importance component 304 can be configured to identify importance of a term in a comment. For instance, the importance component 404 can employ term frequency inverse document frequency (TF-IDF) to determined weights of terms with respect to importance. The importance component 304 can utilize TF-IDF to identify frequency as well as uniqueness of a term. Further, importance can be determined not only with respect to a single term (e.g., unigram) but also sequences of words (e.g., bigrams, trigrams . . . ). The tag component 406 can determine part of speech associated with words or phrases in unstructured text. More particularly, words or phrases can be tagged with a corresponding part of speech based on definition and context. Part of speech can include, among other things, noun, verb, adjective, adverb, preposition, conjunction, pronoun, and interjection.

Returning to FIG. 2, the training component 204 is configured to create a classification model to make decisions regarding approving or rejecting an application, for example, by way of training. Various known or novel processes can be employed to produce the classification model. In a supervised learning approach, a plurality of comments from approved and rejected applications can be employed to train a model. In other words, a set of input data and known responses to input data is provided that adjust model parameters to enable generation of reasonable predictions with respect to new input data. For example, a corpus of training data can be received that includes a predetermined proportion of comments associated with accepted applications (e.g., thirty percent) and rejected applications (e.g., seventy percent) in a credit lending context. Features can be extracted from the comments of the training data set by way of text mining including TF-IDF (Term Frequency-Inverse Document Frequency) and utilized to adjust feature parameters of the classification model. Another set of labeled data can be utilized to test performance of the model. Subsequently, the model can be fine-tuned to meet desired performance metrics (e.g., accuracy, precision, recall . . . ). In one instance, the fine tuning can be accomplished by adjusting hyper-parameter values, which modify the learning processes itself (e.g. rate of learning) as opposed to other parameters that are learned.

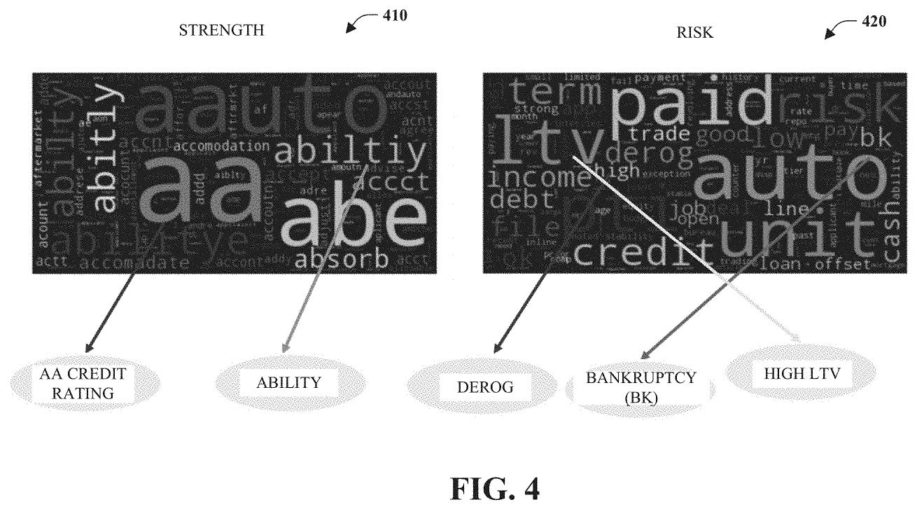

In one instance, the training data can form a dictionary of words associated with past approval and rejection. A machine learning framework can be layered on top of this dictionary of words to classify applications. Referring briefly to FIG. 4, a word cloud diagram is illustrated. As shown, terms or phrases associated with loan application strength are illustrated in word cloud 410, and terms or phrases related to loan application risk are depicted in word cloud 420. For example, a phrase such as “AA credit rating” or the term “ability” can suggest application strength and weigh in favor of approval. By contrast, the terms “Bankruptcy” and “Derog” as well as the phrase “high ltv” can suggest application risk and weigh in favor of rejecting the application.

The classification component 206 of FIG. 2 receives a textual comment, or a collection of features produced by way of text mining, and outputs a classification of either approved or rejected. The classification component 206 can employ a probabilistic model trained to classify applications based on topics, concepts or themes by the training component 204. Numerous techniques can be employed by the classification component 206. In one embodiment, logistic regression can be utilized to model the probability of a certain class such as approve or reject. Alternative techniques can include a naive Bayes classifier, nearest neighbor, support vector machines, decision trees, and random forest, among others. In accordance with another embodiment, deep learning techniques can be employed to implement the classification component 206 including various types of artificial neural networks.

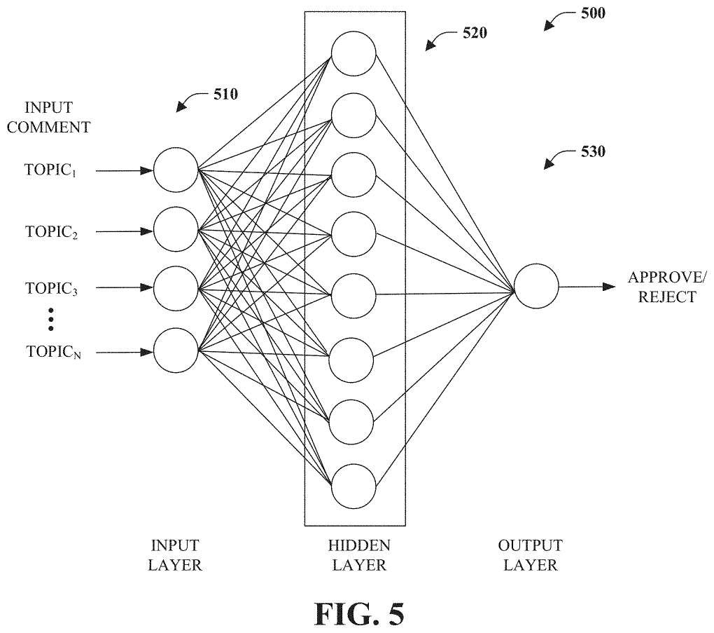

Turning to FIG. 5, depicted is a sample artificial neural network 500 that can be employed in conjunction with classification based on text comments. The artificial neural network 500 includes a number of artificial neurons represented by circles and connections between the artificial neurons. Each artificial neuron is represented by a value that represents all inputs to the neuron. There are three groups of artificial neurons, input layer 510, hidden layer 520, and output layer 530.

The input layer 510 comprises artificial input neurons that bring initial data into the system and pass the data to the hidden layer 520. As shown, the input layer 510 can receive data corresponding to various features, here various topics (TOPIC₁-TOPIC_{N}, wherein “N” is an integer greater than one), specified in a comment. For example, the comment can correspond to text written by an underwriter associated with a loan application including various credit related topics or attributes such as bankruptcy, disposable income, debt to income ratio, and loan to value ratio.

The hidden layer 620 is the portion of the artificial neural network 500 that is capable of learning. The hidden layer 520 nodes perform computations and transfer information from input to output nodes. Here, the neural network 500 can learn to classify by way of supervised learning, unsupervised learning, or reinforcement learning in conjunction with forward and backward propagation. Values of the hidden layer nodes are adjusted during learning, for instance based on a corpus of training data pertaining to comments regarding a loan application and corresponding loan application decisions.

Nodes that comprise the output layer 530 are responsible for computations and transferring information from the neural network 500 to the outside world. Here, the output layer 530 comprises a node that pertains to classification, namely approve versus reject. In one instance, the output layer 530 can identify a confidence level with respect to a default approval classification for example as a percentage. For example, approval with a confidence level of eighty percent. A threshold can be established to determine whether the classification is an approval or rejection. For instance, an approval classification at a confidence level of twenty percent can be deemed a rejection.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull control model. The components may also interact with one or more other components not specifically described herein for sake of brevity, but known by those of skill in the art.

Furthermore, various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, such mechanisms can be utilized by the decisioning system 100 or components thereof, such as the text mining component 202 and the classification component 206.

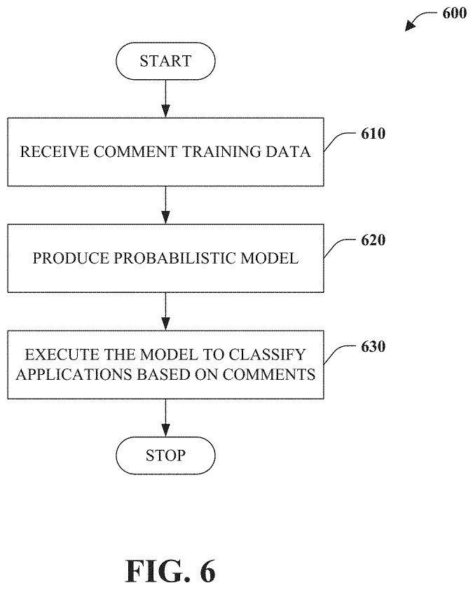

In view of the exemplary systems described above, methods that may be implemented in accordance with the disclosed subject matter will be better appreciated with reference to flow chart diagrams of FIGS. 6-8. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 6 illustrates a method 600 of application classification. The method 600 can be executed by the decisioning system 100 including the training component 204 and classification component 206. At reference number 610, comment training data is received. Such training data can include textual comments regarding an application and corresponding expected classification of either approved or rejected. The training data is employed to produce a probabilistic model at 620. More specifically, the training data can be utilized to modify model parameters to enable reasonable prediction with respect to new comments. In accordance with one embodiment, the probabilistic model can be a classification model, for example employing logistic regression or an artificial neural network, among others. At 630, the predictive model is executed over an input comment, which produces a result such as a probability that the comment corresponds to a class such as an approve class.

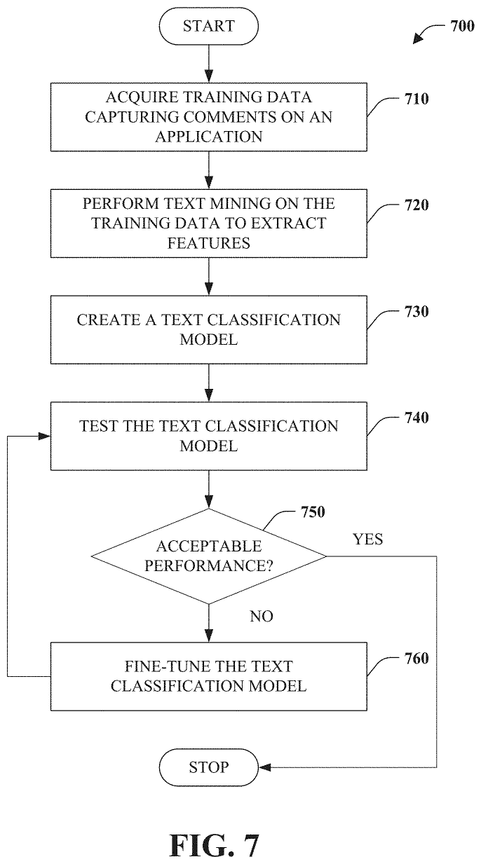

FIG. 7 is a flow chart diagram of a method 700 of producing a predictive model. At reference numeral 710, a corpus of training data is received, retrieved, or otherwise obtained or acquired. In one instance, the training data can correspond to a collection of unstructured comments and labels indicating approval or rejection. At 720, text mining, or text analysis, is performed to transform unstructured data into machine actionable data for further processing. Among other things, text mining can employ natural language processing technologies to perform text extraction of topics and terms associated with topics from unstructured data. In one instance, such text mining can include at least a subset of parsing, tokenizing, lemmatization, stop word removal, as well as frequency and uniqueness determinations, among other things. At numeral 730, a text classification model is created. The text classification model can be produced by a machine learning process operating over text-mined training data with corresponding labels in a supervised learning approach. At 740, the text classification model is tested with a set of test data that includes comments and labels indicative of approval or rejection. The result of testing is a measure of performance, for example in terms of one or more of classification accuracy, precision, or recall, among others. At numeral 750, a determination is made as to whether or not the performance is acceptable, which can be determined by comparison of one or more thresholds to one or more performance metrics. If the performance is not acceptable (“NO”), the method continues at 760, where the text classification model is fine-tuned, for example by adjusting one or more hyper-parameters. Next, the fine-tuned model is retested at 750. If, at 750, it is determined that the performance is acceptable (“YES”), the method terminates. The text classification model is subsequently made available for use in a production environment.

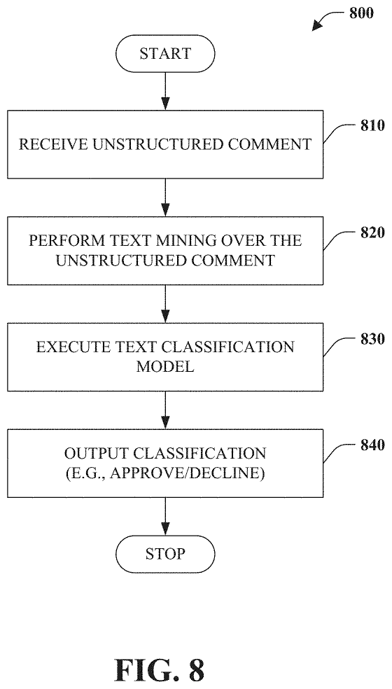

FIG. 8 is a flow chart diagram of a method 800 of text classification. The method can be performed by the decisioning system 100 including the classification component 206. At numeral 810, an unclassified and unstructured comment is received. For instance, the comment can be text written by an underwriter regarding characteristics associated with an application. At 820, text mining is performed over the unstructured comment that extracts characteristics or features of the comment. A text classification model is executed over the result of the text mining at 830. At reference numeral 840, a result received from the text classification model is output. For example, the classification and output can correspond to one of approve or reject associated with a loan application to which the received comments pertain. In one instance, the result can be a confidence measure associated with a default classification. For example, if the default classification corresponds to approval, the confidence measure would be with respect to approval. If the confidence measure is less than a predetermined threshold associated with approval, the class can be deemed a rejection as opposed to approval.

Aspects of the subject disclosure focus on a particular scenario regarding underwriter comments with regard to a loan application for purposes of clarity. For instance, the aspects can be employed to automate decisioning, evaluate performance of an underwriter, and suggest or recommend decisions to underwriters. However, the subject disclosure is not limited to that scenario but rather can be employed in multiple diverse scenarios.

By way of example, and not limitation, aspects of the subject disclosure can be employed in various lending contexts including auto loans, home loans, equipment finance, and credit cards. Further, aspects pertain to the insurance industry to develop search tools that understand context and jargon specific to the industry for fraud detection. For instance, a classification model can be created to automatically identify safe and fraudulent data. As another non-limiting example, aspects of the disclosure can be employed in the medical field, for instance to extract text from hand written medical notes to identify a disease. Feature extraction techniques specific to handwritten character recognition can be developed and used for early disease detection.

In addition, aspects of the disclosure are described primarily in the context of unstructured data. Nonetheless, the aspects can also be applied to semi-structured data. Semi-structured data resides in the middle of a continuum of unstructured and structured data. Unstructured data typically comprises data with no discernable organization or associated data model. Structured data has a high level of organization, such as part of a relational database or spreadsheet table. Semi-structured data includes some structure, but not enough to rise to the level of structured data. As such, text mining can be employed to extract additional structure from the semi-structured data to enable subsequent analysis such as use in classifying a loan application based on corresponding underwriter comments.

Aspects of the disclosure can also be employed in conjunction with other systems to produce further automation. For instance, text mining and additional processing can automatically generate a comment, for example from application data. Alternatively, recommendations can be generated from application data to facilitate manual input of a comment. Subsequently, a decision can be made automatically based on the comment as described above.

Aspects of the subject disclosure concern the technical problem of automatic decisioning over unstructured data. The problem is solved with technical processes such as text mining and machine learning. More specifically, text mining, or analysis, can employ natural language processing to process the unstructured data and produce actionable data or information. Machine learning is layered on top of the results of the text mining to produce a classification model capable of classifying a subject of the unstructured data in one or more ways.

The subject disclosure provides for various products and processes that perform, or are configured to perform, text mining and classification. What follows are one or more exemplary systems and methods.

A system comprises a memory that includes instructions that when executed by the processor cause the processor to receive unstructured data that documents an interpretation of data; perform text mining to extract features of the unstructured data; provide the features to a machine learning model that automatically predicts a class based on the extracted features; and convey the class for display on a display device. In one instance, the unstructured data is a text comment associated with a decision. Further, the text comment can be a credit decision associated with a loan application, and the class is one of approval or rejection of the loan application. The system further comprises instructions that cause the processor to compare the class with a decision of an underwriter to assess quality of the decision of the underwriter. The system further comprises instructions that cause the processor to text mine a corpus of training data set to extract topics from the unstructured data. Further, the machine learning model is configured to learn to associate the features with a level of risk of default. In one instance, the machine learning model learning model is logistic regression. In another instance, the machine learning model is a neural network.

A method comprises executing, on a processor, instructions that cause the processor to perform operations comprising receiving unstructured data capturing an interpretation of data; text mining the unstructured data to extract features; supplying the features to a machine learning model configured to automatically determine a class based on the extracted features; and conveying the class for display on a display device. Receiving the unstructured data comprises receiving a text comment associated with a credit decision. The method further comprises instructions that cause the processor to perform an operations comprising receiving a classification of approval or rejection of a loan application. Further, the method comprises instructions that compare the class with a decision of an underwriter to assess decision quality of the underwriter; and convey, for display on the display device a result of the comparing. Further, the method comprises instructions that cause the processor to perform operations comprising assigning the unstructured data to a class based on comparison of a confidence measure associated with a default class to a threshold. The method further comprises instructions that cause the processor to perform operations comprising training the machine learning mode with a supervised learning approach with a corpus of training data comprising underwriter comments and corresponding loan application decisions. Additionally, supplying the features to the machine learning model comprising providing

A method comprises executing, on a processor, instructions that cause the processor to perform operations comprising: receiving an unstructured text comment of an underwriter documenting factors associated with evaluating a loan application; extracting the factors from the unstructured text comment by way of text mining; supplying the factors to a machine learning model trained to classify a loan application based on factors specified in a corresponding text comment; and outputting a classification of one of approve or reject with respect to the loan application. The method further comprises supplying the factors to a logistical regression model or neural network model. The method further comprises instructions that cause the processor to perform operations comprising comparing the classification with a decision of an underwriter to assess decision quality of the underwriter; and outputting a result of the comparing.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, ‘“X” or ‘Y’” is intended to mean any inclusive permutations of ‘“X” or ‘Y’” For example, if ‘“A’ employs ‘X,’” ‘“A employs ‘Y,’” or ‘“A” employs both ‘X’ and ‘Y,’” then ‘“A” employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

To provide a context for the disclosed subject matter, FIG. 8 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

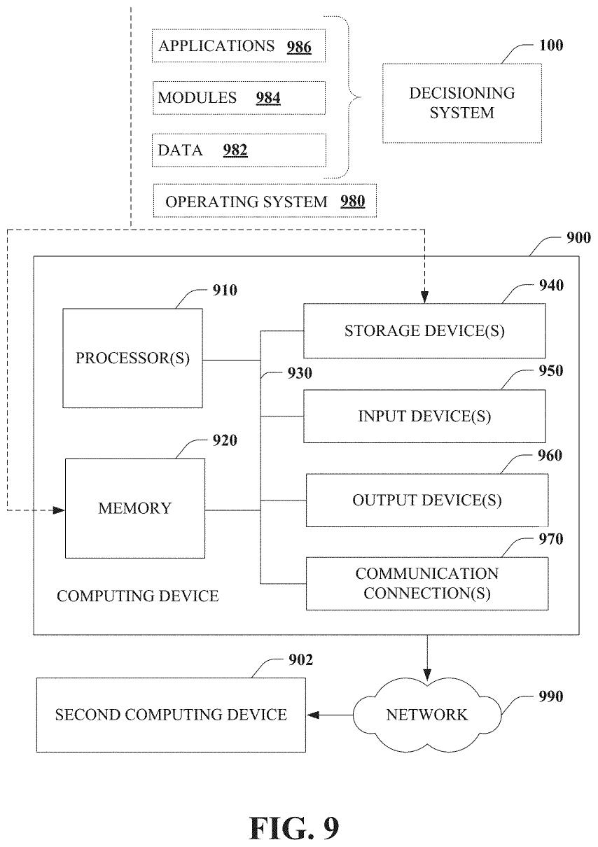

With reference to FIG. 9, illustrated is an example computing device 900 (e.g., desktop, laptop, tablet, watch, server, hand-held, programmable consumer or industrial electronics, set-top box, game system, compute node . . . ). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer executable actions, instructions, and or components stored in the memory 920.

The processor(s) 910 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations with respect to digital image processing and computer graphics.

The computing device 900 can include or otherwise interact with a variety of computer-readable media to facilitate control of the computing device to implement one or more aspects of the disclosed subject matter. The computer-readable media can be any available media that is accessible to the computing device 900 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 900, such as during start-up, can be stored in nonvolatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the decisioning system 100 can be, or form part of, the application 986, and include one or more modules 984 and data 982 stored in memory and/or storage device(s) 940 whose functionality can be realized when executed by one or more processor(s) 910.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the decisioning system 100 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth . . . ), or a combination thereof.

The computing device 900 can also include communication connection(s) 970 to enable communication with at least a second computing device 902 by means of a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In accordance with one implementation, the computing device 900 can execute the decisioning system 100, which is accessible by the second computing device 902. For example, the computing device 900 can form part of a network service platform that exposes the decisioning system 100 as a service to the second computing device 902.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

1. A system comprising:
a processor coupled to a memory that includes instructions that when executed by the processor cause the processor to:
receive unstructured data that documents one or more factors associated with evaluating a loan application, wherein the unstructured data includes a first set of text tokens;
identify a domain associated processing one or more types of loan applications;
perform text mining to extract a set of features from the unstructured data, wherein the performing of the text mining includes:
applying a natural-language processing (NLP) algorithm to the unstructured data to remove a subset of the first set of text tokens and lemmatize one or more remaining text tokens of the first set of text tokens, thereby producing a second set of text tokens;
for each text token of the second set of text tokens:
determining a relevance score of the text token by using the NLP algorithm, wherein the relevance score identifies a degree of relevance of the text token to the unstructured data and the identified domain;
assigning a weight to the text token in accordance with the determined relevance score; and
determining the text token and the assigned weight as being a feature of the set of features;
provide the set of features to a machine learning model that automatically predicts a class based on the set of features; and
convey the class for display on a display device.

2. The system of claim 1, wherein the unstructured data includes a text comment associated with a decision of an underwriter to approve or reject the loan application.

3. The system of claim 2, wherein the one or more factors include credit attributes associated with a loan application.

4. The system of claim 3, wherein the class is one of approval or rejection of the loan application.

5. The system of claim 4, further comprising instructions that cause the processor to:
compare the class with the decision of the underwriter; and
based on the comparison, assess quality of the decision of the underwriter.

6. The system of claim 1, wherein the second set of tokens include one or more topics from the unstructured data, wherein a topic of the one or more topics includes one of collateral, bankruptcy, disposable income, payment to income ratio, and debt ratio.

7. The system of claim 1, wherein the machine learning model is trained to associate the set of features with a level of risk of loan default.

8. The system of claim 1, wherein the machine learning model is a logistic regression model.

9. The system of claim 1, wherein the machine learning model is an artificial neural network.

10. A method comprising:
executing, on a processor, instructions that cause the processor to perform operations comprising:
receiving unstructured data capturing one or more factors associated with evaluating a credit application, wherein the unstructured data includes a first set of text tokens;
identifying a domain associated processing one or more types of credit applications;
text mining the unstructured data to extract a set of features, wherein the text mining includes:
applying a natural-language processing (NLP) algorithm to the unstructured data to remove a subset of the first set of text tokens and lemmatize one or more remaining text tokens of the first set of text tokens, thereby producing a second set of text tokens;
for each text token of the second set of text tokens:
determining a relevance score of the text token by using the NLP algorithm, wherein the relevance score identifies a degree of relevance of the text token to the unstructured data and the identified domain;
assigning a weight to the text token in accordance with the determined relevance score; and
determining the text token and the assigned weight as being a feature of the set of features;
supplying the set of features to a machine learning model configured to automatically determine a class based on the extracted set of features; and
conveying the class for display on a display device.

11. The method of claim 10, wherein the unstructured data includes a text comment associated with a decision to approve or reject the credit application.

12. The method of claim 11, wherein the class includes one of an approval or rejection of the credit application.

13. The method of claim 11, further comprising instructions that cause the processor to perform operations comprising:
comparing the class with a decision of an underwriter to assess decision quality of the underwriter; and
conveying, for display on the display device, a result of the comparing.

14. The method of claim 10, further comprising instructions that cause the processor to perform operations comprising assigning the unstructured data to the determined class based on comparison of a confidence measure associated with the class to a threshold.

15. The method of claim 10, further comprising instructions that cause the processor to perform operations comprising training the machine learning model using a corpus of training data, wherein the corpus of training data includes a plurality of underwriter comments, wherein each underwriter comment is associated with a label that identifies a corresponding credit application decision.

16. The method of claim 10, wherein supplying the set of features to the machine learning model comprises providing the set of features to a logistic regression model.

17. A method, comprising:
executing, on a processor, instructions that cause the processor to perform operations comprising:
receiving an unstructured text comment of an underwriter documenting one or more factors associated with evaluating a loan application, wherein the unstructured data includes a first set of text tokens;
identify a domain associated processing one or more types of loan applications;
perform text mining to extract a set of features from the unstructured text comment, wherein the performing of the text mining includes:
applying a natural-language processing (NLP) algorithm to the unstructured text comment to remove a subset of the first set of text tokens and lemmatize one or more remaining text tokens of the first set of text tokens, thereby producing a second set of text tokens;
for each text token of the second set of text tokens:
determining a term frequency inverse document frequency (TF-IDF) metric of the text token by using the NLP algorithm, wherein the TF-IDF metric identifies a degree of relevance of the text token to the unstructured text comment and the identified domain;
assigning a weight to the text token in accordance with the determined relevance score; and
determining the text token and the assigned weight as being a feature of the set of features;
supplying the set of features to a machine learning model trained to classify a loan application based on the one or more factors specified in a corresponding text comment; and
outputting a classification of one of approve or reject with respect to the loan application.

18. The method of claim 17, wherein the machine learning model includes a logistical regression model.

19. The method of claim 17, wherein the machine learning model includes an artificial neural network.

20. The method of claim 17, further comprising instructions that cause the processor to perform operations comprising:
comparing the classification with a decision of an underwriter to assess decision quality of the underwriter; and
outputting a result of the comparing.
